(19) United States
(12) Patent Application Publication
(10) Pub. No.: US 2019/0299320 A1
(43) Pub. Date: Oct. 3, 2019

(54) WELDING ELECTRODE WITH INTERECHANGEABLE HEAD

(71) Applicant: Charles Curtis Byrum, III, Mobile, AL (US)

(72) Inventor: Charles Curtis Byrum, III, Mobile, AL (US)

(21) Appl. No.: 16/369,244

(22) Filed: Mar. 29, 2019

Related U.S. Application Data
(63) Continuation-in-part of application No. 29/675,060, filed on Dec. 28, 2018.
Application No. 29/675,060 is a continuation-in-part of application No. 29/675,066, filed on Dec. 28, 2018.
(60) Provisional application No. 62/649,694, filed on Mar. 29, 2018.

(51) Int. Cl. B23K 9/26; B23K 9/28

(52) U.S. Cl. CPC B23K 9/26; B23K 9/282

(57) ABSTRACT

An electrode with an interchangeable head is provided. The electrode is generally designed to provide a welding electrode having a head that may be readily removed and interchanged with other electrode heads for improved electrode repair or to affect the characteristics of the electrical arc transmitted by the electrode. The electrode includes a shaft and a head removably secured to the shaft. The head may include a first securing member and a body having a distal end that terminates at a tip having a defined tip angle. The shaft may include a proximal end having a second securing member compatible with the first securing member to removably secure the head to the shaft.

### CROSS-REFERENCE TO RELATED APPLICATIONS

This application claims priority to U.S. Provisional Patent Application Ser. No. 62/649,694, titled “WELDING ELECTRODE WITH INTERCHANGEABLE HEAD”, filed on Mar. 29, 2018 and is a continuation-in-part of U.S. Design patent application Ser. No. 29/675,060, titled “ELECTRODE BODY”, filed on Dec. 28, 2018, and is also a continuation-in-part of U.S. Design patent application Ser. No. 29/675,066, titled “ELECTRODE BODY”, filed on Dec. 28, 2018, all of which are incorporated herein in their entirety by reference.

### FIELD OF THE DISCLOSURE

Embodiments of the present disclosure relate generally to a welding electrode. More specifically, embodiments of the present disclosure relate to a welding electrode with a removable head.

### BACKGROUND

Arc welding is a widely popular form of welding that utilizes an electrical arc to join two work materials together by heating the metal located at the joint of the work materials, and often times a metal-based filler rod, to a molten state to promote intermixing of the materials. Upon cooling, the melted materials solidify to form a metallurgical bond that holds the work materials together. To generate an electrical arc, electrical current is first applied to an electrode associated with a welding torch and an exposed end of the electrode is subsequently positioned in close proximity to an electrically conductive work material to promote discharge from the charged electrode. In non-consumable electrode based welding, such as gas tungsten arc welding (GTAW), also commonly referred to as tungsten inert gas (TIG) welding, the exposed end of the electrode may be tapered such that the exposed end of the electrode draws to a tip. As the width of the electrical arc and the extent to which the electrical arc penetrates the working material may be affected, at least in part, by the angle of the electrode's tip, certain tip angles may be suitable for some welding applications but not others.

Because what is considered a suitable or desirable tip angle may vary widely from welding application to welding application, commercially available non-consumable electrodes are not generally manufactured or sold with tapered ends. Rather, at the time of manufacture and sale, the ends of such electrodes are flat and untapered. Accordingly, consumers must personally tailor and taper the ends of the electrodes to the desired tip angle after purchase. To taper the ends of purchased electrodes, individuals commonly use multipurpose grinders, which can introduce a variety of contaminants into the electrode tip, which, in turn, can result in erratic arc action while welding. Depending on the type of electrode used, grinding of the electrode can also introduce toxic or radioactive contaminants into the air which can adversely affect an individual's health if inhaled. In many instances, the electrodes are tapered by hand, i.e., the angle at which the end of the electrode is introduced to the grinder is dictated by an individual's movement of the electrode. As such, it is commonplace for the resulting tip angle to depart from that intended or desired.

Moreover, non-consumable electrodes known and commonly used within the art are generally of unitary construction such that non-tapered and tapered portions of the electrode cannot be separated without breaking. Accordingly, in the event that tapered portion of the electrode becomes damaged or deformed, users generally must remove the electrode from the welding torch, either re-taper the damaged electrode or taper a new electrode, and subsequently recombine the re-tapered or new electrode with the welding torch. Regardless of whether the damaged electrode is re-tapered or a new electrode is used, contaminants are introduced into the air of the surrounding work environment each time an electrode is tapered via grinding, thus increasing a user's risk of inhaling the same. Depending on the welding application, this time-consuming process may be carried out numerous times over the course of a welding job. Accordingly, the use of known non-consumable electrodes may contribute to decreased work productivity and negatively impact users' health.

New apparatuses, systems, and methods providing electrodes that reduce and/or alleviate the above-identified problems are described herein.

### SUMMARY

In one aspect, an electrode with an interchangeable head is provided. The electrode is generally designed to provide an electrode having a head that may be readily removed and interchanged with other electrode heads for improved electrode repair or to affect the characteristics of the electrical arc transmitted by the electrode. The electrode includes a shaft and a head removably secured to the shaft. In an embodiment, the head may include a first securing member and a body having a distal end that terminates at a tip having a defined tip angle and a proximal end disposed opposite the distal end. In certain embodiments, the shaft may include a proximal end having a second securing member that is adapted to interlock with the first securing member to removably secure the head to the shaft. In some embodiments, the shaft may have a body adapted to pass through the collet of a welding torch and a distal end adapted to be received within a back cap of a welding torch.

To facilitate the transmission of electrical current from a power supply to a desired working material, the shaft and the head may both be constructed of an electrically conductive material or a combination of electrically conductive materials. The electrode may be a non-consumable electrode such that neither the shaft nor the head of the electrode is consumed when subjected to normal arc welding amperages. To this end, in some embodiments, the electrode may be constructed primarily of tungsten. In certain embodiments, the electrode may comprise at least 97% tungsten by weight. In some embodiments, the electrode may include an alloying element. In an embodiment, the electrode may include at least one of thorium oxide, cerium oxide, lanthanum oxide, zirconium oxide, and yttrium oxide.

In the event that the head of the electrode becomes damaged, deformed, or is otherwise undesirable, users may remove the defective head by disassociating the securing member of the shaft from the securing member of the defective head, removing the defective head, and replacing the defective head with a new, undamaged or otherwise more desirable head by engaging the securing member of the new head with the securing member of the shaft. Unlike known electrodes, the majority of the electrode of the present disclosure may be left within or associated with a welding torch while the head of the electrode is being repaired or substituted. Accordingly, in another aspect, the present disclosure is directed toward a system and method for improved electrode repair. A plurality of heads having tips of different angles may be provided to enable users to vary the characteristics of the electrical arc emitted from the electrode by interchanging heads. Accordingly, in another aspect, the present disclosure is directed toward a system and method of varying the electrical characteristics of an electrode.

The foregoing summary has outlined some features of the apparatus, system, and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the apparatus, system, and methods disclosed herein. Those skilled in the pertinent art should also realize that such equivalent designs or modifications do not depart from the scope of the device and the methods of the present disclosure.

### DESCRIPTION OF THE DRAWINGS

These and other features, aspects, and advantages of the present disclosure will become better understood with regard to the following description, appended claims, and accompanying drawings where:

FIG. 1 is a partial perspective view of an electrode embodying features consistent with the principles of the present disclosure;

FIG. 2 is a partial perspective view of a disassembled electrode having features consistent with the principles of the present disclosure;

FIG. 3 is a cross-sectional view along line 3-3 shown in FIG. 2 of a disassembled electrode having features consistent with the principles of the present disclosure;

FIG. 4A is a side view of a head embodying features consistent with the principles of the present disclosure;

FIG. 4B is a side view of a head embodying features consistent with the principles of the present disclosure;

FIG. 5 is a cross-sectional view of a disassembled electrode having features consistent with the principles of the present disclosure;

FIG. 6 is an exploded view of a welding torch in which an electrode having features consistent with the principles of the present disclosure associated therewith;

FIG. 7 is a side view illustrating a plurality heads embodying features consistent with the present disclosure, each emitting an electrical arc onto a working material; and

FIG. 8 is a top perspective view of a disassembled electrode having features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. The term “removably secured” and grammatical equivalents thereof are used herein to mean the joining of two components in a manner such that the two components are secured together, but may be detached from one another and re-secured together without requiring the use of specialized tools. As used herein, “a defined, tightening motion” and grammatical equivalents thereof are used to refer to a rotating motion, which is preferably a clockwise motion, of a securing member. As used herein, “a defined, untightening motion” and grammatical equivalents thereof are used to refer to a rotating motion, which is preferably a counter-clockwise motion, of a securing member that is opposite of the “defined, tightening motion.”

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). References to “one embodiment”, “an embodiment”, “some embodiments”, “an example embodiment”, etc., indicate that the embodiment described may include a particular feature, structure, or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is submitted that it is within the knowledge of one of skilled in the art to effect such feature, structure, or characteristic in connection with other embodiments whether or not explicitly described.

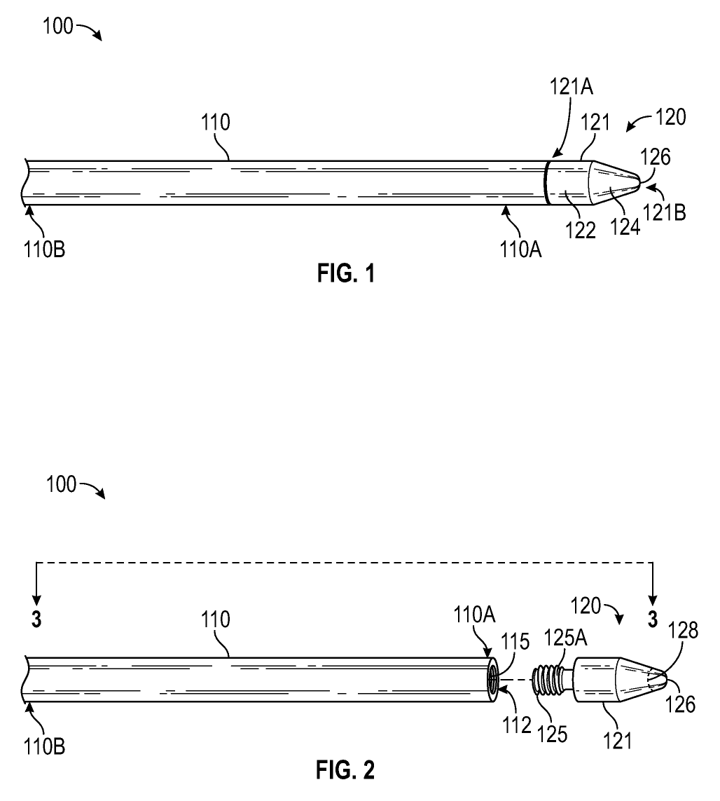

Turning now to the drawings, FIGS. 1-8 illustrate certain embodiments of an electrode, or components thereof, for use in arc welding applications. While the electrode of the present disclosure may sometimes be described in the context of being utilized in non-consumable electrode based arc welding applications, such as GTAW/TIG welding, those skilled in the art will appreciate that the electrode, in its various embodiments, disclosed herein may be utilized for other welding or non-welding applications and still fall within the scope of the present disclosure.

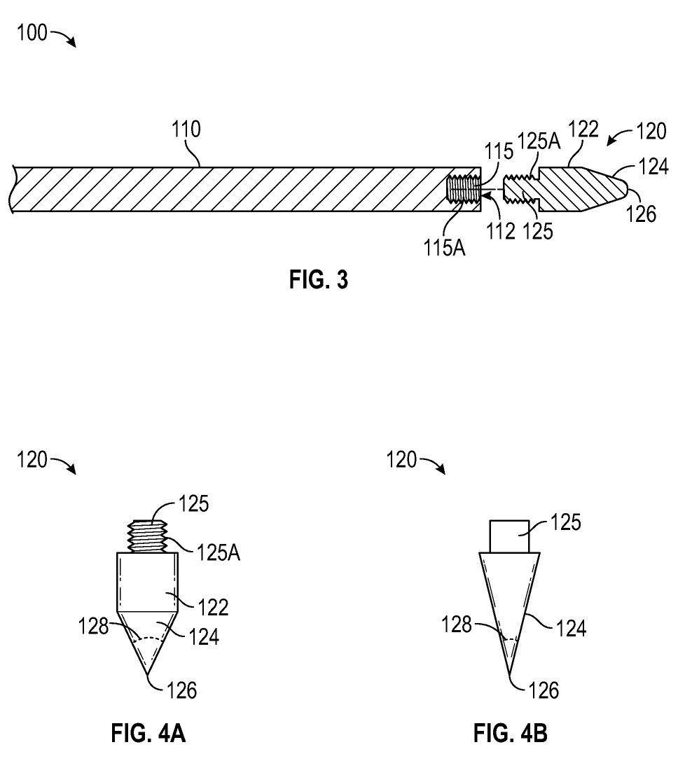

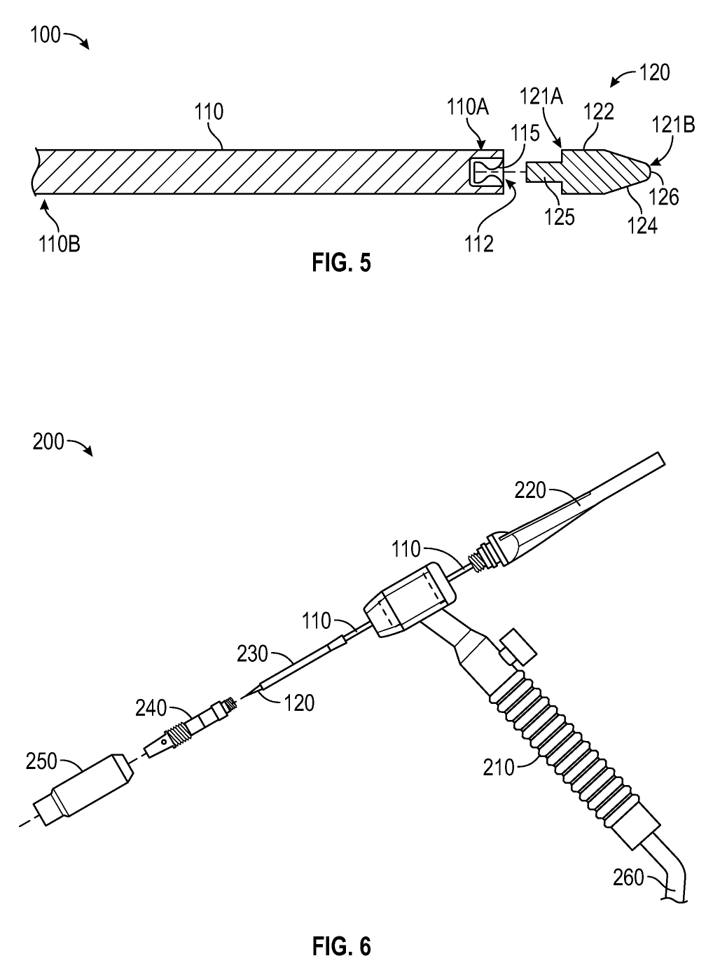

FIG. 1 shows an electrode 100 constructed in accordance with an embodiment of the present disclosure. As shown in FIG. 1, the electrode 100 includes an elongated shaft 110 with a head 120 removably secured thereto. The shaft 110 has a proximal end 110A to which the head 120 may be removably secured and a distal end 110B opposite the proximal end 110A. To facilitate securement of the head 120 to the shaft 110, the proximal end 110A of the shaft 110 may, in some embodiments, be configured to receive a first securing member 125 associated with the head 120. In one such embodiment, at least one end 110A, 110B of the shaft 110 may have a cavity 112 formed therein. In an embodiment, the proximal end 110A of the shaft 110 may have a cavity 112 formed therein such that at least a portion of the proximal end 110A of the shaft 110 is hollow, as shown best in FIGS. 3 and 5. As shown best in FIG. 3, the cavity 112 may extend longitudinally within the proximal end 110A of the shaft 110 and be of sufficient dimension such that the securing member 125 of the head 120 is substantially housed within the proximal end 110A of the shaft 110 when inserted into the cavity 112. For instance, in one embodiment, the cavity 112 may have a diameter of approximately three millimeters and a length of approximately three and a half millimeters while the first securing member 125 has a diameter and length of approximately three millimeters, though it is understood that the dimensions of the cavity 112 and/or the first securing member 125 may vary without departing from the inventive subject matter disclosed herein. To accommodate most welding applications and welding torches, the shaft 110 may have a diameter ranging from approximately one to approximately four millimeters, though the dimensions of both the shaft's 110 diameter and length may vary to accommodate various welding applications and/or welding torches. As such, in other embodiments, the diameter of the shaft 110 may be smaller than one millimeter or exceed four millimeters. As shown in FIGS. 1 and 2, in one embodiment, the shaft 110 may have a body that is generally cylindrical in shape to facilitate passage of the shaft 110 into the back cap 220 and through the collet 230 of a welding torch 200. In other embodiments, the body of the shaft 110 may retain other shapes, such as a rectangular cuboidal shape.

As shown in FIGS. 2-5, in an embodiment, the head 120 includes a body 121 and a first securing member 125. In one embodiment, the body 121 of the head 120 may have a proximal end 121A from which the first securing member 125 outwardly extends and a distal end 121B opposite the proximal end 121A. The body 121 of the head 120 may be tapered such that the distal end 121B of the body 121 terminates at a tip 126 having a defined tip angle 128. In one embodiment, the body 121 of the head 120 may be defined by a non-tapered portion 122 extending from the proximal end 121A toward the distal end 121B of the body 121 as well as a tapered portion 124 that terminates at the body's 121 distal end 121B. As shown best in FIG. 1, the diameter of the proximal end 121A of the body 121 may be equal to the diameter of the proximal end 110A of the shaft 110. In such embodiments, the non-tapered portion 122 of the body 121 may also have a diameter equal to the diameter of the proximal end 110A of the shaft 110. In some embodiments, the shaft 110 and head 120 may be shaped and sized such that the portion of the electrode 100 extending from the distal end 110B of the shaft 110 to the end of the non-tapered portion 122 of the body 121 is substantially uniform in diameter, as shown in FIG. 1. The diameter of the tapered portion 124 gradually decreases as it approaches the distal end 121B of the body 121 to form the tip 126 of the electrode head 120. As shown best in FIGS. 1-4A and 5, the non-tapered portion 122 of the body 121 may retain a generally cylindrical shape while the tapered portion 124 draws inward to retain a generally conical shape. In other embodiments, the body 121 of the head 120 may be devoid of a non-tapered portion 122 such that the body 121 is defined solely by a tapered portion 124 that extends from the proximal end 121A to the distal end 121B of the body 121, as shown in FIG. 4B. In such embodiments, the diameter of the body 121 gradually decreases as it extends from the proximal end 121A to the distal end 121B such that the entirety of the head's body 121 generally retains a conical shape.

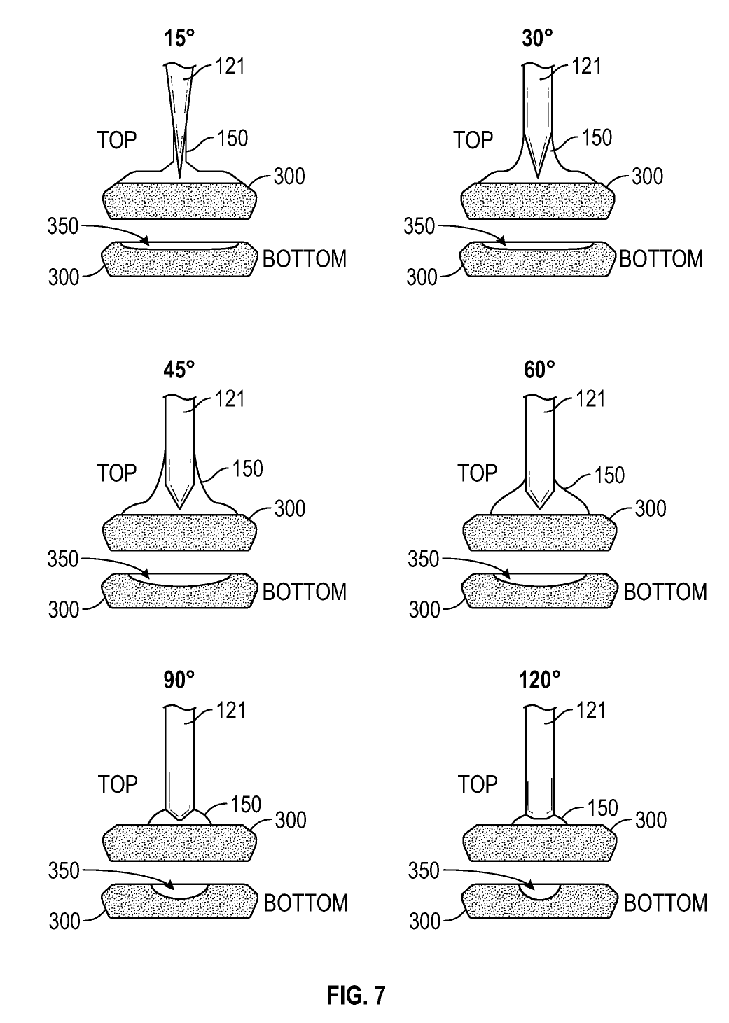

FIG. 7 illustrates a series of electrode heads 120 having tips 126 of various tip angles 128, each transmitting an electrical arc 150 onto a working material 300. As shown in the top portion of each illustration provide in FIG. 7, as indicated by the identifier “TOP”, the tip angle 128 exhibited by the tip 126 of the electrode head 120 may inversely relate, at least in part, to the width of an electrical arc 150 transmitted thereby when the electrode 100 is electrically connected to a power supply (not shown). That is, generally, the smaller the tip angle 128 of the tip 126 is, the wider the electrical arc 150 will be. Conversely, as further shown in the bottom portion of each illustration provided in FIG. 7, as indicated by the identifier “BOTTOM”, the tip angle 128 may directly relate, at least in part, to the depth in which the electrical arc 150 transmitted by the head 120 penetrates the working material 300. That is, the wider the tip angle 128, generally, the deeper the electrical arc 150 will penetrate the working material 300. Accordingly, the tip angle 128 of the head 120 may be adjusted to affect various characteristics of the electrical arc 150 emitted by the electrode 100 in order to accommodate various welding applications. To provide a wide array of arc widths and penetration depts, the distal end 121B of the body 121 of the head 120 may be manufactured so that the tip 126 assumes a tip angle 128 ranging from 1 degree, such that the distal end 121B tapers to a fine point, to 180 degrees, such that the body 121 is not tapered and the tip 126 is flat. In one embodiment, the tip 126 may have a tip angle 128 ranging from 15 degrees to 120 degrees, inclusive, to accommodate most welding applications.

The diameter and sharpness of the tip 126 may be adjusted during the manufacture of the electrode 100 to accommodate various welding applications. As shown in FIGS. 1-3, in some embodiments, the tip 126 may be rounded or flat to provide a larger tip diameter which may provide increased durability and electrical arc 150 stability for longer welding jobs or welding applications requiring higher amperages of electrical current. Conversely, as shown in FIGS. 4A-5 and 7, the tip 126 may be pointed to provide a smaller diameter which may facilitate easier arc starting and prove effective for shorter welding jobs or applications utilizing lower amperages of electrical current.

The shaft 110 and head 120 are removably secured together by engaging the first securing member 125 associated with the head 120 with a second securing member 115 associated with the shaft 110. In one embodiment, the second securing member 115 may be formed or disposed within a cavity 112 formed within the proximal end 110A of the shaft 110. In such embodiments, the first and second securing members 125, 115 may be engaged, at least in part, by inserting the first securing member 125 into a cavity 112 within the shaft 110 so that the proximal end 110A of the shaft 110 and the proximal end 121A of the body 121 are adjacent when the electrode 100 is assembled, as shown in FIG. 1. To this end, the diameter of the first securing member 125 may be approximately equal to or smaller than the diameter of the cavity 112 and may be smaller than the diameter of the proximal end 121A of the body 121. As shown in FIGS. 2-5, in an embodiment, the first securing member 125 may comprise a male member retaining a knob or knob-like shape. In such embodiments, the length of the first securing member 125 may be approximately equal to the length of the cavity 112 within the shaft 110 so that the cavity 112 is substantially filled when the first securing member 125 is inserted therein. For instance, in one embodiment, both the length of the cavity 112 and the first securing member 125 may be approximately three millimeters. In an embodiment, the first securing member 125 is integrally formed with the body 121 such that the head 120 comprises a single, unitary component. Alternatively, the first securing member 125 and the body 121 may be two separate components removably or permanently secured together to form the head 120.

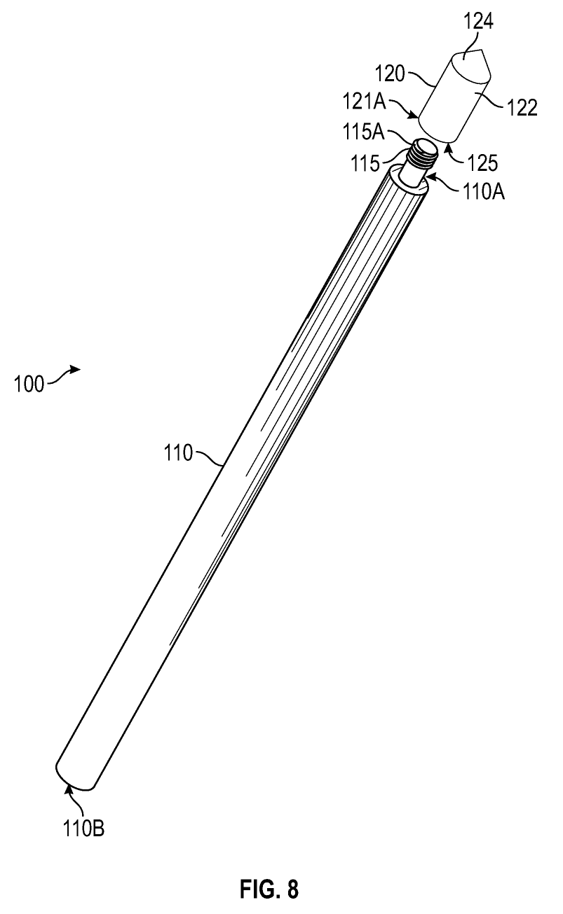

FIG. 8 shows another embodiment of an electrode 100 constructed in accordance with the principles of the present disclosure, wherein the characteristics at or within the proximal ends 110A, 121A of the shaft 110 and the head 120 are reversed from the embodiments shown in FIGS. 2 and 3. As shown in FIG. 8, in one embodiment, the proximal end 121A of the head's body 121 may have a cavity formed therein in which the first securing member 125 may be formed or disposed and the second securing member 115 may be defined, at least in part, by a male member retaining a knob or knob-like shape that extends outwardly from the proximal end 110A of the shaft 110. In such embodiments, the first and second securing members 125, 115 may be engaged, at least in part, by inserting the second securing member 115 into the cavity formed in the proximal end 121A of the head's body 121.

In some embodiments, the first securing member 125 and the second securing member 115 may be configured to interlock together to removably secure the head 120 to the shaft 110. In one embodiment, the first securing member 125 may include a first set of threading 125A and the second securing member 115 may include a second set of threading 115A, where the first and second set of threading 125A, 115A are configured to interlock. In such embodiments, the shaft 110 and the head 120 may be removably secured together by aligning the first set of threading 125A and the second set of threading 115A and subsequently rotating the head 120 in a defined, tightening motion until either the first securing member 125 is completely disposed within the cavity 112 of the proximal 110A of the shaft 110, for embodiments such as that shown in FIGS. 2 and 3, or the second securing member 115 is completely disposed within the cavity of the head, for embodiments such as that shown in FIG. 8, and the proximal end 110A of the shaft 110 is directly adjacent the proximal end 121A of the head's body 121. To remove the head 120 from the shaft 110, the head may be rotated in a defined, untightening motion until the first set of threading 125A and the second set of threading 115A are no longer interlocked or otherwise engaged.

In other embodiments, the first and second securing members 125, 115 may be configured to interlock by merely inserting one securing member into the other. In some embodiments, the securing members may be interlocked by inserting the first securing member 125 into the cavity 112 of the shaft 110, as shown best in FIG. 5. In another embodiment, the securing members may be interlocked by inserting the second securing member 115 into a cavity formed within the head 120. In one embodiment, the second securing member 115 may comprise a clip fastener disposed within a cavity 112 formed within the proximal end 110A of the shaft 110, as shown in FIG. 5. The clip fastener may have two arms resiliently biased towards each other in a closed configuration, as further shown in FIG. 5, such that when the first securing member 125 is inserted into the cavity 112, thereby forcing the arms of the fastener clip apart, the resilient bias of the fastener clip's arms secures the first securing member 125 in place. To remove the head 120 from the shaft 110, users may pull the head 120 away from the proximal end 110A of the shaft 110 until the first securing member 125 is dislodged from the second securing member 115 and the cavity 112. In other embodiments, the head 120 may have a cavity formed therein and the first securing member 125 may comprise a clip fastener disposed within the cavity and the second securing member 115 may be defined, at least in part, by a male member adapted to be inserted into the clip fastener.

In another embodiment, the first securing member 125 may include one or more protrusions (not shown), such as a retractable push button, and the second securing member 115 may include one or more female grooves, notches, or holes (not shown) formed within the cavity 112 of the shaft 110 that are configured to receive the one or more protrusions of the first securing member 125 therein. The one or more protrusions may extend outwardly from the first securing member 125 in a direction generally perpendicular to the axial direction in which the head 120 extends from the first securing member 125 to distal end 121B of the body 121. The one or more female members may extend outwardly from the cavity 112 in a direction generally perpendicular to the axial direction in which the cavity 112 extends. In such embodiments, the head 120 may be removably secured to the shaft 110 by inserting the first securing member 125 into the cavity 112 until the protrusions of the first securing member 125 interlock with the notches or grooves within the cavity 112 of the shaft 110. To remove the head 120 from the shaft 110 in such embodiments, the first securing member 125 may be dislodged from the cavity 112 by pulling the head 120 away from the shaft 110 such that the protrusions retract from being interlocked with the grooves or notches within the cavity 112. In some embodiments, the cavity 112 of the shaft 110 may have one or more generally L-shaped grooves formed therein (not shown) and defined by an elongated first portion and a second portion perpendicular to the first portion. In such embodiments, the head 120 may be removably secured to the shaft 110 by first aligning the protrusions with the first portion of the one or more L-shaped grooves, inserting the first securing member 125 into the cavity 112, and subsequently rotating the head such that the protrusions enter the second portion of the one or more L-shaped grooves, thereby preventing vertical movement of the head 120 away from the shaft 110. In some instances, the cavity 112 of the shaft 110 may have the above-described one or more protrusions extending therefrom and the first securing member 125 may have the foregoing one or more female notches, grooves, or holes formed therein.

In alternative embodiments, the shaft 110 and head 120 may be removably secured via magnetic attraction. In such embodiments, the proximal end 110A of the shaft 110 may exhibit a first magnetic polarity and the first securing member 125 may exhibit a second magnetic polarity such that when the first securing member 125 is inserted into the cavity 112 of the shaft 110 the head 120 and the shaft 110 are magnetically secured together. In addition to the foregoing, one of skill in the pertinent art will readily appreciate that other securing mechanisms, instruments, devices, or shaft 110 and head 120 configurations suitable for removably securing the head 120 to the shaft 110 may be used without departing from the inventive subject matter disclosed herein.

To facilitate the transmission of electrical current from a power supply to a desired working material 300, the shaft 110 and the head 120 are both constructed of an electrically conductive material or combination of electrically conductive materials. The shaft 110 and head 120 may, in some embodiments, each be primarily constructed of a metal material having a melting point of at least 3,000 degrees Fahrenheit. In an embodiment, the materials of construction may be such that neither the shaft 110 nor the head 120 of the electrode 100 are consumed when subjected to normal arc welding amperages. To this end, the shaft 110 and head 120 may, in some embodiments, each be primarily constructed of a material having a melting point of at least 6,000 degrees Fahrenheit. In one such embodiment, the shaft 110 and head 120 may each be constructed primarily of tungsten. In certain embodiments, the composition of the electrode 100 may be at least 97% tungsten by weight. The composition of the electrode may also include one or more oxide alloying elements, such as cerium oxide, lanthanum oxide, yttrium oxide, thorium oxide, zirconium oxide, or combinations thereof.

In an embodiment, the electrode 100 is a 2.0% thoriated tungsten electrode having a composition comprising about 97.0% to 97.5% tungsten by weight and about 1.7% to 2.2% thorium oxide by weight. In another embodiment, the electrode 100 may be a pure tungsten electrode having a composition comprising about 99.5% tungsten by weight. In another embodiment, the electrode may be a 2.0% ceriated tungsten electrode having composition comprising about 97.0% to 97.5% tungsten by weight and about 1.8% to 2.2% cerium oxide by weight. In another embodiment, the electrode 100 may be a 1.5% lanthanated tungsten electrode having a composition comprising about 97.0% to 97.8% tungsten by weight and about 1.3% to 1.7% lanthanum oxide by weight. In another embodiment, the electrode 100 may comprise a 2.0% lanthanated tungsten electrode having a composition comprising about 97.0% to 97.5% tungsten by weight and about 1.8% to 2.2% lanthanum oxide by weight. In another embodiment, the electrode 100 may comprise a rare earth electrode having a composition comprising about 97.0% tungsten by weight and a balance of cerium oxide, lanthanum oxide, yttrium oxide, and/or other suitable oxide alloying elements. In another embodiment, the electrode 100 may comprise a 1.0% percent zirconiated tungsten electrode having a composition comprising about 99.1% tungsten by weight and 0.15% to 0.40% zirconium oxide by weight.

In some embodiments, the shaft 110 of the electrode 100 may include indicia indicative of, and corresponding to, the electrode's 100 material composition. In some embodiments, the distal end 110B of the shaft 110 may be colored to indicate the type and/or material composition of the electrode 100. In one embodiment, the distal end 110B of the shaft 110 may be color coded in accordance with the International Standard Organization's, the American Welding Society's, or other organization's color-coding guidelines. For instance, in embodiments where the electrode 100 is a pure tungsten electrode, the distal end 110B of the shaft 110 may be colored green. In embodiments where the electrode 100 is a 2.0% ceriated tungsten electrode, the distal end 110B of the shaft 110 may be colored grey. In embodiments where the electrode 100 is a 1.5% lanthanated tungsten electrode, the distal end 110B of the shaft 110 may be colored yellow. In embodiments where the electrode 100 is a 2.0% lanthanated tungsten electrode, the distal end 110B of the shaft 110 may be colored blue. In embodiments where the electrode 100 is a rare earth electrode, the distal end 110B of the shaft 110 may be colored green, preferably a different shade of green than that of the pure tungsten electrode. In embodiments where the electrode 100 is a 2.0% thoriated tungsten electrode, the distal end 110B of the shaft 110 may be colored red. In embodiments where the electrode is a 1.0% zirconiated tungsten, the distal end 110B of the shaft 110 may be colored brown. The shaft 110 may include additional or other indicia including, but not limited to, symbols, letters, numbers, or combinations thereof to identify the electrode's 100 type and/or material composition. In some embodiments, the head 120 may also include indicia consistent with the foregoing.

The shaft 110 and the head 120 may each be formed using known milling techniques, forging techniques, combinations thereof, or other techniques or processes commonly used in the construction of welding electrodes. The cavity 112 within the shaft 110 or cavity within the head 120, depending on the embodiment, may be formed by boring the proximal end of the shaft 110 or head 120, respectively. To form the tapered portion 124 of the head 120, the distal end 121B of the body 121 may be longitudinally and concentrically grinded. Preferably, the grinder utilized to grind the distal end 121B of the body 121 is utilized solely for the shaping of electrodes of the same or similar composition to avoid potential cross-contamination of the electrode 100. In some instances, the body 121 may be tapered during the initial formation of the head 120, i.e., during the milling and/or forging of the head 120, thereby alleviating or reducing the need for grinding of the head 120. Unlike conventional electrodes, the electrode 100 of the present disclosure may be tapered during manufacture and prior to consumer purchase in order to alleviate the need for end user electrode grinding and reduce the amount of toxic or radioactive contaminants a user may inhale over the course of a welding job. Accordingly, in some embodiments, the electrode 100 of the present disclosure may be preformed to have a tapered head prior to user receipt.

Once the shaft 110 and the head 120 are removably secured together, the electrode 100 may be combined with a welding torch 200 and used for a variety of welding applications. As shown in FIG. 6, the welding torch 200 may include a body 210, a back cap 220, a collet 230, a collet body 240 that partially houses the collet 230, a gas nozzle 250 secured to the collet body 240 and configured to direct shielding gas supplied to the welding torch 200 to a desired location, and a gas/electrical conduit 260. The electrode 100 may be combined with the welding torch 200 by inserting the shaft 110 through the collet 230, through the body 210, and into the back cap 220 such that the distal end 110B of the shaft 110 is positioned on a first side of the body 210 and is enclosed by the back cap 220 and the tip 126 extends beyond the gas nozzle 250 on a second side of the body 210. The extent to which the tip 126 extends beyond the gas nozzle 250 may be adjusted by loosening or tightening the back cap 220. After the electrode 100 is combined with the welding torch 200, a power supply (not shown) may be engaged to direct electrical current to the electrode 100 via the gas/electrical conduit 260 to generate an electrical arc 150 between the tip 126 and a working material 300 to reduce the working material 300 to a molten state at a desired location. To redirect the electrical current applied to the working material 300 back to the power supply, a work lead (not shown) may interconnect the working material 300 and the power supply. To prevent molten working material from reacting with oxygen in the surrounding work environment, a shielding gas, such as argon or helium, may be supplied to the welding torch 200 via the gas/electrical conduit 260 and directed by the gas nozzle 250.

Standard electrodes known and commonly used within the art are generally of unitary construction such that the shaft and tapered head portion cannot be separated without breaking the electrode. Accordingly, in the event that the tip, or other portion of an electrode's head, becomes damaged or deformed or a different tip angle is desired, users have traditionally been required to remove the electrode from the welding torch, resharpen the electrode or sharpen a new electrode, and then recombine the resharpened or new electrode with the welding torch due to such unitary construction. However, because the shaft 110 and head 120 of the electrode 100 of the present disclosure are removably secured such that they can be readily associated or disassociated in the manner disclosed herein, users utilizing the electrode 100 of the present disclosure can simply remove the damaged, deformed, or otherwise undesirable head and replace it with an undamaged or otherwise desirable electrode head without also having to remove the shaft from the welding torch. Accordingly, in another aspect, the present disclosure is directed toward a method and system for improved electrode repair. The system for improved electrode repair may include a shaft 110 having some or all of the features of the embodiments described herein and a plurality of electrode heads 120 having some or all of the features of the embodiments described herein, where each electrode head 120 is configured to removably secure to the shaft 110 in the manner described herein. The method for improved electrode repair may include the steps of removing a first electrode head 120 from the shaft 110 of the electrode 100 by disengaging the first electrode head's securing member 125 from the securing member 115 of the shaft 110 and securing a second electrode head 120 to the shaft 110 by engaging the second electrode head's 120 securing member 125 with the shaft's 110 securing member 115.

In some embodiments, each electrode head 120 within the plurality of heads may have a tip 126 of a different tip angle 128 from the other heads 120 within the plurality of electrode heads to enable users to vary the characteristics of the electrical arc 150 emitted from the electrode 100 by interchanging electrode heads 120. For instance, in applications where a user needs to transition from using a wider electrical arc 150 with less work material 300 penetration to using a narrower electrical arc 150 providing deeper work material 300 penetration, a user may start out by using a first electrode head 120 having a tip angle 128 of 15 degrees and subsequently switch to a second electrode head 120 having a tip angle 128 of 120 degrees by securing and removing the electrode heads 120 to the shaft 110 in the manner described herein. In some embodiments, the plurality of electrode heads may include one or more electrode heads having a tip angle 128 of 15 degrees, one or more electrode heads having a tip angle 128 of 30 degrees, one or more electrode heads having a tip angle 128 of 45 degrees, one or more electrode heads having a tip angle 128 of 60 degrees, one or more electrode heads having a tip angle 128 of 90 degrees, and one or more electrode heads having a tip angle 128 of 120 degrees, as shown in FIG. 7. Accordingly, in another aspect, the present is directed toward a system and method for varying the electrical arcing characteristics of an electrode.

The foregoing description, for purposes of explanation, used specific nomenclature to provide a thorough understanding of the described embodiments. However, it will be apparent to one skilled in the art that may of the specific details are not required in order to practice the described embodiments. Thus, the foregoing descriptions of the specific embodiments described herein are presented for the purposes of illustration and description. They are not meant to be exhaustive or to limit the embodiments to the precise forms disclosed. It will be apparent to one of ordinary skill in the art that many modifications and variations are possible in view of the above teachings.

The Detailed Description section is intended to be used to interpret the claims. The Summary and Abstract sections may set forth one or more but not all exemplary embodiments of the present disclosure as contemplated by the inventor, and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1) A welding electrode, comprising:
a head having a body and a first securing member, wherein the body includes a distal end terminating at a tip having a defined tip angle; and
an elongated shaft having a proximal end with a second securing member adapted to interlock with the first securing member to removably secure the head to the shaft, wherein the head and the shaft are electrically conductive.

2) The welding electrode of claim 1, wherein the welding electrode comprises tungsten.

3) The welding electrode of claim 2, wherein the welding electrode comprises at least 97% tungsten by weight.

4) The welding electrode of claim 2, wherein the welding electrode comprises at least 99.5% tungsten by weight.

5) The welding electrode of claim 2, wherein the welding electrode comprises at least one of thoriated tungsten, ceriated tungsten, lanthanated tungsten, zirconiated tungsten, and yttriated tungsten.

6) The welding electrode of claim 1, wherein the welding electrode comprises an alloying element.

7) The welding electrode of claim 1, wherein the welding electrode comprises at least one of thorium oxide, cerium oxide, lanthanum oxide, zirconium oxide, and yttrium oxide.

8) The welding electrode of claim 1, wherein the welding electrode has a melting point of at least 6,000 degrees Fahrenheit.

9) The welding electrode of claim 1, wherein the defined tip angle is between 15 degrees and 120 degrees, inclusive.

10) The welding electrode of claim 1, wherein the body includes a tapered portion and a non-tapered portion.

11) The welding electrode of claim 10, wherein the non-tapered portion has a first diameter and the proximal end of the shaft has a second diameter equal to the first diameter.

12) The welding electrode of claim 1, wherein the proximal end of the shaft includes a cavity adapted to receive the first securing member.

13) The welding electrode of claim 1, wherein the first securing member includes a first set of threading and the second securing member includes a second set of threading compatible with the first set of threading.

14) A welding electrode, comprising:
a head having a first securing member; and
a shaft having a body including a proximal end and a distal end, the proximal end having a second securing member compatible with the first securing member to removably secure the head and the shaft together, wherein the body is adapted to pass through a collet of a welding torch and the distal end is adapted to be received within a back cap of the welding torch.

15) The welding electrode of claim 14, wherein the head includes a tapered portion terminating at a tip having a defined tip angle.

16) The welding electrode of claim 14, wherein the welding electrode comprises at least one of tungsten and an alloying element.

17) The welding electrode of claim 14, wherein the first securing member includes a male member.

18) The welding electrode of claim 14, wherein the second securing member includes a male member.

19) The welding electrode of claim 14, wherein the shaft includes indicia corresponding to the welding electrode's material composition.

20) A welding electrode, comprising:
an electrically conductive head having a body and a first securing member extending from the body, wherein the body includes a tapered portion that terminates at a tip having a defined tip angle between 15 degrees and 120 degrees, inclusive; and
an electrically conductive elongated shaft having a proximal end with a second securing member adapted to interlock with the first securing member to removably secure the head to the shaft, wherein the welding electrode comprises at least 97% tungsten by weight.
